(19) United States
(12) Patent Application Publication
(10) Pub. No.: US 2023/0128899 A1
(43) Pub. Date: Apr. 27, 2023

(54) COMPUTER-IMPLEMENTED METHOD FOR PLANNING AND/OR CONTROLLING A PRODUCTION BY A PRODUCTION SYSTEM, AND PRODUCTION PLANNING AND/OR CONTROL SYSTEM FOR PRODUCTION OPTIMIZATION

(71) Applicant: ZF Friedrichshafen AG, Friedrichshafen (DE)

(72) Inventors: Georg SCHNEIDER, Urbar (DE); Leander TENTRUP, Bous (DE); Gerhard SCHALLER, Wadgassen (DE)

(73) Assignee: ZF Friedrichshafen AG, Friedrichshafen (DE)

(21) Appl. No.: 17/914,190

(22) PCT Filed: Mar. 10, 2021
(86) PCT No.: PCT/EP2021/055995

§ 371 Date: Sep. 23, 2022

(30) Foreign Application Priority Data
Mar. 23, 2020 (DE) 10 2020 203 718.3

(51) Int. Cl. G05B 19/418; G06N 3/126; G06Q 10/04; G06Q 10/0631; G06Q 50/04

(52) U.S. Cl. CPC G05B 19/41865; G06N 3/126; G06Q 10/04; G06Q 10/06315; G06Q 50/04

(57) ABSTRACT

A computer-implemented method for planning and/or controlling a production by a production system comprising a plurality of production sections and production lines. A production planning and/or control system for production optimization is also disclosed.

The invention relates to a computer-implemented method for planning and/or controlling a production by a production system, a production planning and/or control system for production optimization, and a computer program.

In production, products comprising material goods and services are produced based on production factors comprising materials and resources. For example, gearboxes are produced. Within the gearbox production, other material goods are created, such as output shafts. Production planning and/or control optimizes the entire production system.

A number of methods for production planning and/or control are known in the prior art, for example, traditional systems comprise successive planning of primary data management, production program planning, quantity planning, scheduling, workshop control, order monitoring, and sales control. In addition, integrated IT systems comprising production planning and/or control are known.

Furthermore, optimization methods for production planning and/or control are known, for example constraint-based approaches based on linear programming. However, these approaches do not scale to real problem sizes. In addition, local search or branch-and-bound algorithms for optimization are known. In addition, classic scheduling algorithms such as multiprocessor scheduling are known, but they can only be applied to simplified models. In addition, evolutionary optimization algorithms are known, but they require large amounts of resources, such as time or computing power, and a good initial solution.

Currently, a human controller plans the production workflows of a specific product, workpiece or semi-finished part, such as the production of the output shaft with or without support from the known optimization methods. The production consists of a plurality of production sections that the part must pass through in sequence. For this purpose, the controller must consider a wide range of input variables. Planning, for example, which parts should be produced on which line/sub-line at which point in time should be optimal with respect to a wide range of optimality criteria. A complicating factor is that the parameters that determine the available production workflows often change over time, as do the optimality criteria. This leads to the need for frequent re-planning, which must however be carried out as quickly as possible so that production does not stop or produce suboptimal results.

Against this background, the object of the invention is how production sequences, worker assignments and supplier orders can be devised from given requirements and how the production sequences can be evaluated and optimized on the basis of predefined criteria.

The invention is first presented for the sake of clarity.

The invention achieves this object by means of a method and an adaptive system that optimizes complex processes such as production workflows on the basis of given evaluations and by means of a virtual representation of production. The system adapts very quickly to changes that affect production and guarantees a production schedule that can be implemented at any time. At the same time, the system generates solutions for highly complex production conditions.

The invention allows a longer planning horizon compared to the prior art, for example several weeks instead of a few days. As an example, the invention was used in the production of an output shaft, wherein a planning horizon of several weeks was realized. For example, a planning horizon of two weeks is realized. The length of the planning horizon increases the duration of the method accordingly. However, it was established during the invention process that the method according to the invention, advantageously, only scales linearly with the planning horizon in contrast to known optimization methods, which in general scale exponentially. This is accompanied by a significant reduction in costs through a more efficient planning process, an increase in assembly output and a lower capital commitment through stock reductions.

Furthermore, the invention supports the increasing complexity of products in the future, for example increased variance or additional constraints, which can only inadequately be reproduced by the known control tools, if at all. For example, about 500 different types of gearboxes are built in the applicant's factories. With the development of further generations and further gearboxes, the variance will increase significantly once again. The resulting costs, for example from weekend working or production downtimes through to delivery bottlenecks to the customer, are avoided by means of the invention.

A compact description of the invention is presented by analysis of input values or inputs entered into the system, and output values or outputs provided by the system. Inputs to the system include direct and indirect inputs. Outputs from the system include control-related and informational outputs.

As a result, the method and the system provide all control-related information for an optimal production sequence, worker assignment, and supplier orders. This production sequence is implemented automatically or only after approval by the controller. Within the context of the invention, optimal means optimal with respect to a given total cost function. The controller also has the option of influencing the result by starting a new run with modified inputs. In order to support such decisions, the system provides detailed informational outputs concerning line occupancy, inventory development, and forecast completion times.

The direct inputs include inputs that are expected at each optimization run of the system. An optimization run is usually initiated if a change in the production parameters has occurred. Another cause is, for example, a change in the weighting of the different optimization criteria by the controller. The controller is a human operator who has previously accomplished this planning alone. However, any other change in the input conditions usually leads to a new system run. For example, the following inputs are direct inputs:
Production parameters: worker situation, machine capabilities, materials availability, initial warehouse and buffer stocks, and/or supplier capacity;
Material requirements: which material/semi-finished product must be produced at which time and/or weighting/prioritizing of the parts to be produced;
Optimality criteria: maximum utilization of all machines and staff, minimization of delays, lowest warehouse stock levels, minimization of material flows from areas far apart within the factory and/or weighting them against each other and
Constraints: In contrast to the optimality criteria, these must be strictly adhered to for an optimization run to be started. These are, for example, priorities of requirements with rank 1 which must always be produced at a specified time, storage/intermediate storage quantities that must not be exceeded, no transport of parts from one production line/store to another production line/store that is not currently practical for logistical or other reasons. The constraints can be changed by the controller. The planning horizon, for example, the number of hours or days over which the production schedule is to be planned in advance, also forms one of the constraints.

The indirect inputs are only integrated into the system when structural things change in production or in the production process.

The invention simulates the production system and thus provides a virtual representation of the production process and/or the production system. The virtual representation is a digital twin of the entire production process and/or production system. The digital twin models all dependencies within the production. This model, in turn, contains the production parameters as variables. The invention always keeps the model up-to-date with the actual conditions and dependencies within the real production process and/or the real production system.

The control-related outputs are mandatory for implementation in the production planning and/or control system of a factory and comprise:
Optimized production sequence: Which material is required on which line and at what time?
Worker assignment: How many workers are or will be needed on which line on which shift?
Supplier orders: What delivered material and how much is available at what time?

The informational outputs offer added value in terms of explanatory power, for example why a material is delayed, and make it easier for the controller to make their own evaluation of the optimization result. The informational outputs comprise:
requirements coverage and projected production completion dates, relevant to logistics, for example;
indication of capacity utilization, bottlenecks, and critical paths, and
projected temporal progression of semi-/finished parts and/or stock levels.

With regard to a further overview of the invention, it is pointed out that the method and the system optimize a total cost function of the production system. The cost function determines the minimum-cost production workflows from the technically efficient production processes. The cost function represents the total costs of a production process, which are derived from the production factors used, which are then multiplied by their respective market prices or weightings. For example, the total cost function is defined from:
Requirements fulfilment: delay time, with weighting for each requirement;
Production capacity utilization: periods of production downtime and
Secondary production conditions: transport between lines, setup times.

Mathematical functions are used to combine these criteria into a numerical value, wherein the above criteria can be weighted differently.

Example: Total costs=α*Σ_Delay″ (b)*Weighting (b)+β*Production_downtime+γ*Setup_times+ . . . , where α≥0, β≥0, γ≥0, . . . represents a weighting of the various partial terms and is variable. The summation is applied over all material requirements.

For the sake of clarity, the method according to the invention proceeds as follows:

The current production parameters, requirements, optimality criteria and constraints are the inputs that are received, for example, as data. An initial production sequence is then devised using a fast optimization procedure, that is, having a runtime of a few seconds. This production sequence is input into a subsequent thorough and longer optimization procedure, for example into an evolutionary algorithm as an initial population, or initialization. Potentially, more thorough but more time-consuming optimizations can be initiated, such as genetic optimizers with a larger population and other hyper-parameters.

The initial production sequence is also input into the real production system or the real factory for implementation. As soon as a better result with respect to the total cost function is available from one of the downstream thorough optimization procedures, it is output and implemented directly by the system in real production or output to a human controller for assistance. This ensures that the better result matches the production sequence that has already been started. This is ensured by the fact that every planning run of a previous optimizer that has just been put into production for the current time is a constraint of the downstream optimizer.

When an event occurs that affects production, such as machine failure or a changed worker situation, a new initial production sequence is devised and the method starts again from the beginning.

According to one aspect, the invention provides a computer-implemented method for production planning and/or control in a production system. The production system comprises a plurality of production sections and production lines. The method comprises the steps:
Simulating the production system, the production planning and/or control,
in the simulation, carrying out a first sub-method and a second sub-method wherein
the first sub-method comprises the steps
   prioritizing material requirements in the production sections depending on their impact on the optimization of a cost function of the production system,
   selecting one of the material requirements in order of prioritization, adjusting at least one requirement quantity and/or one requirement deadline of materials in preceding production sections to implement the material requirements and reserving the materials and the adjusted requirement quantity and/or the requirement deadline
   selecting another of the material requirements, repeating the previous step until the materials and the adjusted requirement quantities and/or requirement deadlines for all of the prioritized material requirements are reserved, and obtaining a production sequence
and the second sub-method comprises the steps
   fixing a first production period in the production sequence and
   optimizing the production sequence outside the fixed first production period to further optimize the cost function
wherein
the production system is open-loop and/or closed-loop controlled according to the optimized production sequence obtained in the second sub-method.

The first sub-method corresponds to the fast optimization procedure, which returns the initial production sequence as the first result within a few seconds. A first result after a very short period of time is relevant, since production must never be stopped after an incident. The goal of optimization is to meet demand in combination with maximizing production capacity utilization, which means that production downtimes are as few as possible.

The second sub-method corresponds to the more thorough optimization procedure.

The first sub-method specified by the method according to the invention quickly delivers the initial results relative to the second sub-method.

The simulation provides a virtual representation of the production system, production planning and/or production control, in which the entire production system is implemented as a digital twin. For example, the simulation includes the simulation of bottlenecks or critical paths. The simulation simulates a future state of the production system, according to one aspect of the invention. This enables planning horizons stretching as far into the future as desired, for example in the range of several weeks. Through the simulation, the optimization achieved by the method according to the invention, and thus the entire production system, is adapted to production changes in an advantageous way.

The material requirements comprise material types. Material types include raw materials, such as iron, consumables, such as screws, basic supplies, such as energy, unfinished products, for example pre-assembled components that still need to be assembled, finished products, for example finished products and merchandise ready for shipment.

Sequencing or sequence planning, also known as sequencing and scheduling, involves the formation of a production sequence of production orders in the production planning.

The fixing ensures that the output of the second sub-method can also be implemented. As a result of the fixing, a part of the production sequence specified by the fixing can no longer be changed in the second sub-method. According to one aspect of the invention, all input parameters are fixed in time for a certain period of time. The fixing is implemented, for example, by means of a prefix in the production sequence, worker situation and/or in the deliveries obtained from the first sub-method. Due to the fixing, the second sub-method can require no more time than is covered by the fixing. For example, the time until the end of the current shift is used as the fixation time. The fast optimizer optimizes over all production periods of the production. The first production period optimized by the fast optimizer is then implemented in the real factory and can no longer be changed. Therefore, the slower but more thorough optimizer optimizes further production periods outside the fixed period.

According to one aspect of the invention, the material requirements are prioritized according to material type, requirement quantity, requirement deadline, priority and/or weighting.

A prioritized material requirement is implemented is executed when there are sufficient input materials available to fully meet the requirement. In this case, the input materials are reserved for this requirement. Reserving the input materials ensures that the production sequences defined in this way can be implemented, in other words, that orders created in this way can be executed in any case.

In accordance with a further aspect, the invention provides a production planning and/or control system. The system comprises a processing unit that is designed to implement a method according to the invention.

In accordance with a further aspect, the invention provides a computer program. The program contains commands that cause a system according to the invention to implement the method according to the invention when the program runs on the system.

Further embodiments of the invention are obtained from the dependent claims, the drawings, and the description of preferred exemplary embodiments.

According to one aspect of the invention, an iteration of the second sub-method is terminated if no significant optimization of the production sequence is obtained, and a further iteration of the second sub-method is started. This abort criterion accelerates the method and thus further optimizes the production system.

The period determined by the fixing does not have to be fully utilized. For example, if the second sub-method makes no or only minimal progress with regard to the optimization task within a time period that is, for example, less than the fixation time, a current iteration of the second sub-method is ended. In the event that the second sub-method finds a significantly better optimization in a period that is less than the fixation period, this optimization is output earlier and accepted directly. This further accelerates the method and improves the optimization. According to one aspect of the invention, the controller proactively requests new optimizations from the second sub-method.

If the improvement of the optimization of the cost function was too small and no change in the constraints has occurred in the meantime anyway, according to one aspect of the invention the second sub-method will be iterated once again with a search that is now shifted backwards by a further time unit. The time horizon can be extended backwards.

According to a further aspect of the invention, to carry out the second sub-method an evolutionary algorithm is executed, which is initialized with the production sequence obtained in the first sub-method or a mutation of this.

Evolutionary algorithms are inspired by the way natural organisms evolve and are processed according to the following procedure:
Initialization: the first generation of solution candidates is generated. According to the invention, the first generation is the initial production sequence. The initial production sequence is generated by means of the method according to the invention, i.e. the fast optimizer.
Evaluation: each solution candidate of the generation is assigned a value for a fitness function according to its quality. The fitness function is the target function of the evolutionary algorithm. The model for the fitness function is biological fitness, which indicates the degree of adaptation of an organism to its environment. In the evolutionary algorithm, the fitness of a production sequence describes how well the production sequence solves the underlying optimization problem.
Iterate through the following steps until an abort criterion is met:
   Selection: selection of individuals for recombination
   Recombination: combination of the selected individuals
   Mutation: random changing of the descendants
   Evaluation: Each solution candidate of the generation is assigned a value for the fitness function according to its quality.
   Selection: determination of a new generation.

Typical abort criteria are listed below.

The advantage of an evolutionary algorithm is that it can represent a solution in a different form in order to better process it and output it again later in its original form, comparable to genotype-phenotype mapping or artificial embryogenesis. This is especially useful when the representation of a possible solution can be simplified considerably and the full complexity of the solution does not need to be processed in memory. Evolutionary algorithms include genetic algorithms. Genetic algorithms use binary problem representation and therefore usually require a genotype-phenotype mapping. With evolutionary algorithms, a solution candidate is sought exclusively by mutation, recombination does not take place. Genetic algorithms take recombination into account. According to one aspect of the invention, the execution of the evolutionary algorithm relies on one of the following evolutionary strategies:
Adaptive customization or ⅕ success rule: The ⅕ success rule states that the proportion of the successful mutations of the initial production sequence, i.e. mutations that improve the production workflow, should be approximately one fifth of all mutations. If the proportion is greater, the variance of the mutations should be increased, if the proportion is smaller, it should be decreased.
Self-adaptivity: Each individual has an additional gene for the mutation strength itself. This is of course not possible in biology, but evolution in the computer finds a suitable variance in this way without the human limitation. In the computer, recombination and mutation are adapted according to the mutation strength.

For example, the genotype for the thorough optimization consists of the data structure used by the rapid optimizer. The solution of the fast optimizer is used as the initial population and the sequence of the material requirements in the data structure is then changed by recombination and mutation. In this case, the modification operator changes the order of a randomly selected material requirement of a randomly selected production area. The recombination operator takes two chromosomes of parents and produces two chromosomes of children. This is achieved, for example, by recombining permutations. The phenotype is derived from the genotype by executing the fast optimizer on the modified data structure.

This further improves the adaptive production optimization.

According to another aspect of the invention, production parameters, optimality criteria and/or constraints are simulated. Production parameters include worker situation, machine capabilities, material availabilities, material buffers and/or supplier capacities. Optimality criteria include maximum utilization of the machines and/or workers, minimization of delays, lowest stock levels and/or minimization of material flows. The constraints include material requirements priorities, maximum storage and/or material buffer sizes, transport conditions, planning horizon, and/or supplier capacities. The entire production system is thereby further optimized. According to one aspect of the invention, these data form inputs for the simulation.

According to another aspect of the invention, a shift operation of workers is simulated and the production lines in the simulation are assigned workers and a change in the assignment of workers to the production lines takes place at least depending on the material requirements and/or material stocks. The entire production system is thereby further optimized. According to one aspect of the invention, each production line is initially fully assigned, which means that the capacity utilization according to the production parameter is a maximum. If the allocation is greater than the number of available employees, see Production Parameters, the allocation will be reduced accordingly. Various factors such as material stock, line capability, requirements, etc. can be taken into account when deciding which line to reduce.

According to a further aspect of the invention, a check is carried out to determine whether materials lacking for the material requirement can be delivered in compliance with the requirement deadline. If the check is positive, a delivery is ordered. The delivered materials are reserved. If the result of the check is negative, a further materials requirement that is compliant is reserved. Materials include materials produced from a preceding production section that form input materials for the following production section. The materials also include delivered materials, such as delivered input materials. If insufficient input materials are available during production, for example in individual production processes, in the second check it is checked whether it is possible to deliver them at the current time, in particular in compliance with constraints such as supplier capacities, delivery times, and/or supplier control. The entire production system is thereby further optimized. If an input material can be both produced and delivered, according to a further aspect of the invention the initial delivery and buffer stocks are reduced as described above, with the difference that, in contrast to initial buffer stocks, the delivery time must be taken into account. According to one aspect of the invention, the second check, the supplier orders, supplier capacities, delivery times and/or supplier control are input into the simulation.

According to another aspect of the invention, material requirements in the production sections are prioritized in such a way that slack times of the production system are optimized. Slack times are captured in the cost function via delays. This optimizes delay minutes. The slack time refers to the remaining time of an order. In the context of the invention, the meaning of material requirements includes the meaning of order. This is the time interval from the current processing time to the target end time, minus the remaining processing times. The slack time of an order is determined, for example, as follows: January 20: Delivery date, January 10: Date of priority determination, 4 days remaining lead time→20−10−4=6 days slack time. When optimizing the slack time, according to one aspect of the invention the priority of the order is determined for both cases of production faults and of fault-free production. In order to optimize the slack times, according to one aspect of the invention a least-slack-time scheduling algorithm is integrated into the method, which is executed when the method is carried out. According to a further aspect of the invention, the optimization of the slack times is included in the simulation.

According to a further aspect of the invention, the material requirements in the production sections are prioritized in such a way that, when a workflow plan of the production system is optimized, a fulfilment of the material requirements is combined with a maximization of production capacity utilization. According to one aspect of the invention, the optimization of slack times combines the fulfilment of the material requirements with maximization of production capacity utilization. In this way, a minimum production downtime is achieved.

According to a further aspect of the invention, the production duration for the material requirements is taken into account when adjusting the requirement deadline and/or the material requirement is selected depending on the respective line capacity on the production lines.

The period of time required for the production is deducted from the original requirement deadline. For example, 800 materials of type B are to be ready by 2:00 p.m. The production of this material requirement in a second production section takes 4 hours. In order to obtain 800 materials of type B, 700 materials of type A must also be produced on a first production section. This means that the requirement deadline in the first production section is 10:00 a.m. The entire production system is further optimized by taking into account the production period in preceding production sections.

The line capacity is a constraint and relates to technical limitations of the respective production line. The material requirement that can run on a production line is not necessarily the material requirement with the highest priority, depending on the line capacity. By taking into account the line capacity, the entire production system is thus further optimized. According to one aspect of the invention, the line capacity is input into the simulation.

According to another aspect of the invention, the production system comprises material buffers between the production sections. The material requirements are reduced depending on the material buffers. A production section thus comprises one or more production lines and one material buffer. The material buffers comprise the materials produced in the preceding production lines. The sizes of each material buffer are included in the production parameters. For example, if a requirement quantity for type B material is 1000 pieces and one material buffer comprises 200 pieces of type B material, then another 800 pieces of type B material must be produced. According to a further aspect of the invention, the buffer stocks are included in the simulation. The entire production system is thereby further optimized.

According to a further aspect of the invention, a data structure is generated from the material requirements obtained, which comprises at least material type, requirement quantity and requirement deadline for each production section. The data structure comprises an index structure by means of which the entries in the data structure are referenced among one another. The second sub-method is executed to process the data structure. The data structure is used to assign the production lines, distribute workers and/or generate supplier orders. The data structure represents the material requirements grouped by production sections. For example, the data structure is provided as a database, for example as an object-oriented database. This enables improved access to the data comprising at least material type, requirement quantity and requirement deadline, because the data is treated as objects. In addition, it enables semantic relationships between the objects to be known, for example by means of the index structure. This knowledge can be used when querying the data using a query language, such as object query language. The data structure also provides an informative overview of the production workflows for the controller. According to one aspect of the invention, the data structure is generated from material type, requirement quantity and requirement deadline, priority and weighting.

According to a further aspect of the invention, open-loop and/or closed-loop control-related outputs and/or informational outputs are provided. The open-loop and/or closed-loop control-related outputs include production sequences, worker assignment and/or supplier orders. Informational outputs include material requirements coverage, completion dates, capacity utilization, bottlenecks, critical paths, and/or temporal progression of the production system. The outputs are output, for example, via optical display devices or acoustic systems and enable the controller to gain a clear overview of the production workflows.

According to a further aspect of the invention, in the simulation a digital twin of a real factory is generated, a planning horizon is determined for the digital twin and the real factory is controlled by means of the planning horizon.

Another embodiment of the production planning and/or control system according to the invention comprises at least one interface via which communication is provided between the system and a controller of the system. The system provides control and/or control-related outputs and/or informational outputs of the system to the controller via the interface. The interface provides the controller with optimization results. The interface thus allows the controller to request optimization results from the system.

Another embodiment of the production planning and/or control system according to the invention comprises a cloud infrastructure. The cloud infrastructure comprises cloud-based storage. A simulation of the production system, the production planning and/or control takes place in the cloud. By means of the invention, a digital twin of the entire production system is thus obtained in the cloud. The simulation and the real production system are controlled in the cloud, according to one aspect of the invention. Thus, according to one aspect of the invention, the method according to the invention is provided as software-as-a-service. The inputs and outputs are provided via appropriate interfaces, for example wireless interfaces, for example WLAN interfaces.

According to a further aspect, the system comprises at least one display device that displays open-loop and/or closed-loop control-related outputs and/or informational outputs from the system. This facilitates an overview of the production workflows for the controller.

The invention is illustrated in the following exemplary embodiments. In the drawings:

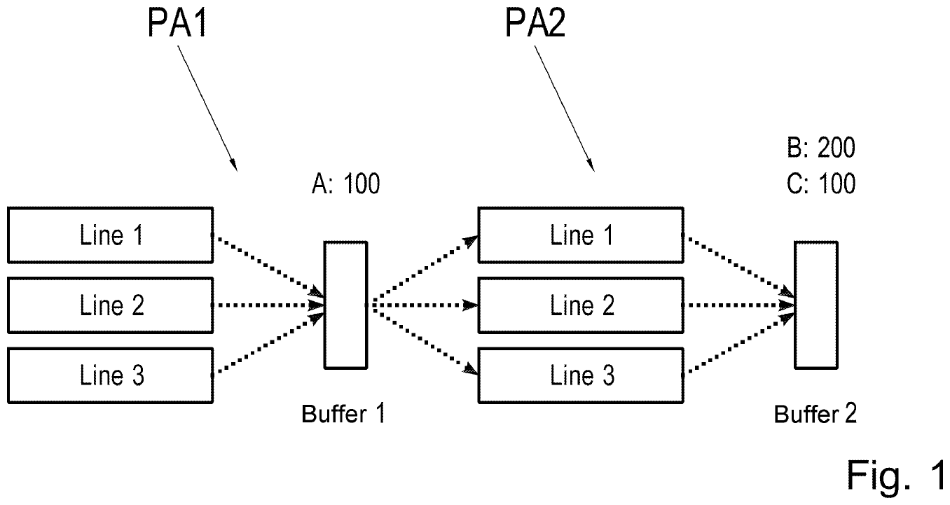

FIG. 1 shows an exemplary embodiment of a production model,

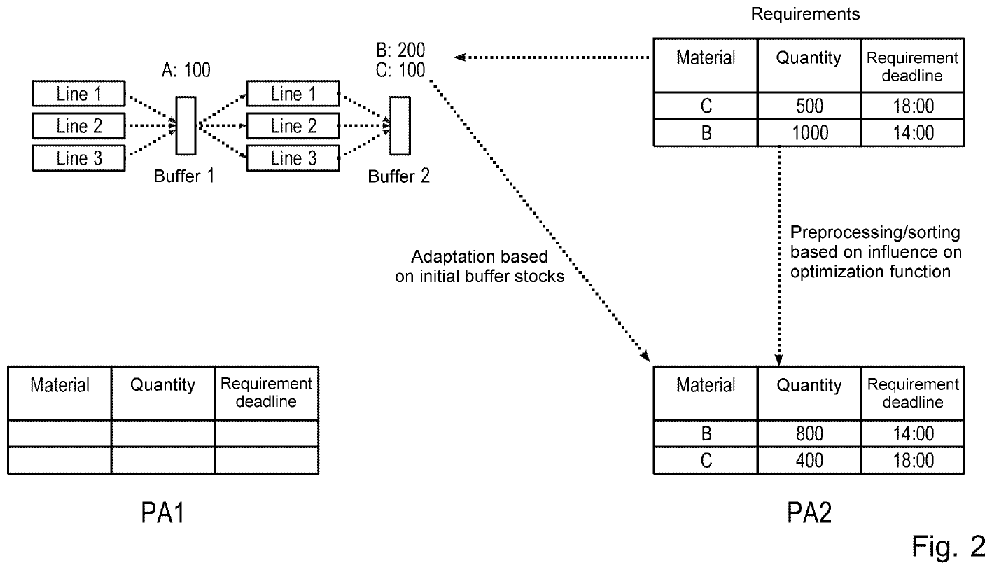

FIG. 2 shows an exemplary embodiment of a data structure generated according to the invention,

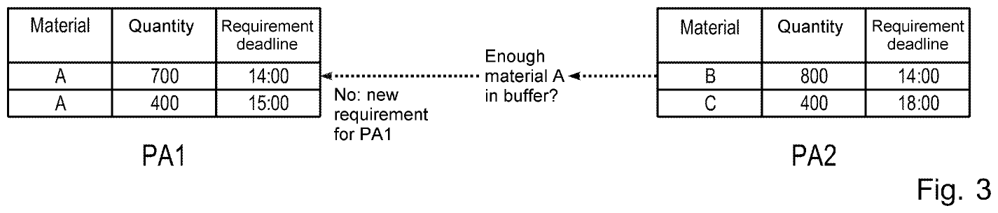

FIG. 3 shows another exemplary embodiment of the data structure of FIG. 2,

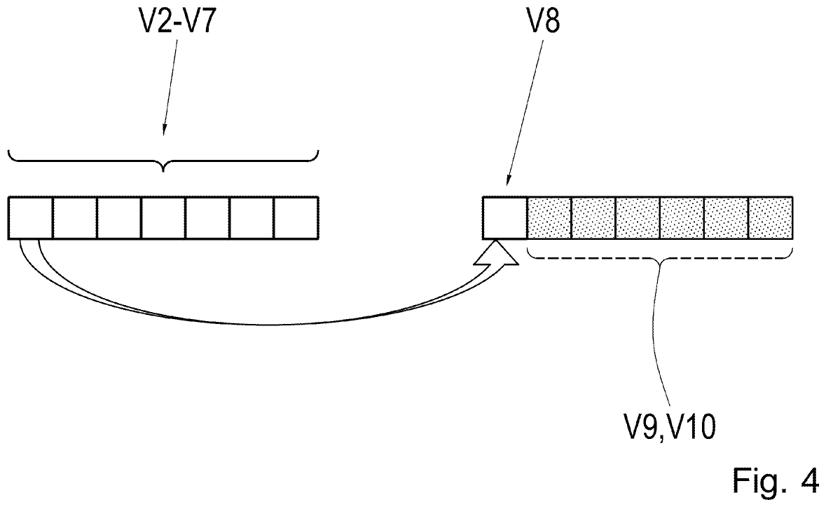

FIG. 4 shows a schematic drawing of the fixing of a production sequence,

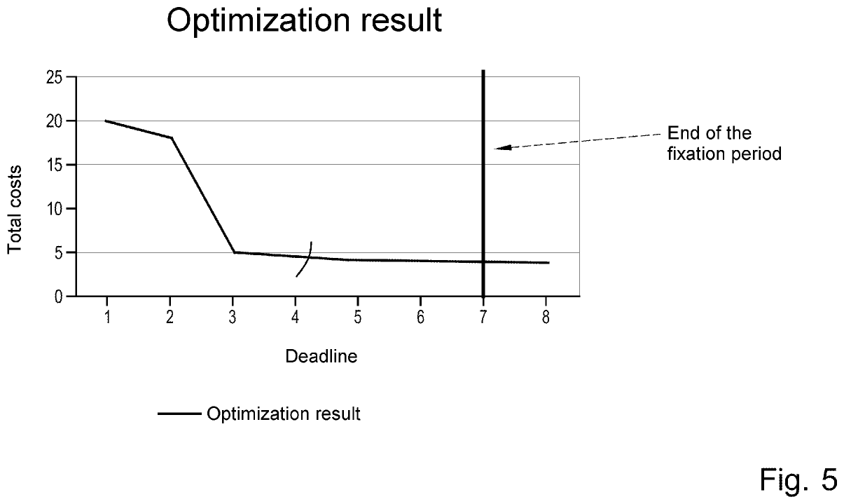

FIG. 5 shows an illustration of a temporal profile of a production sequence optimized according to the invention,

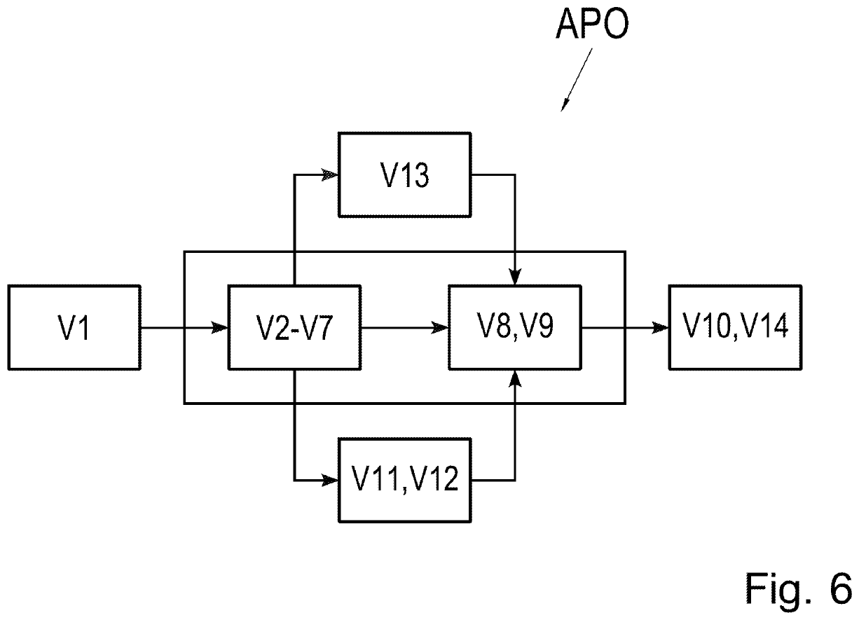

FIG. 6 shows a schematic representation of the method according to the invention,

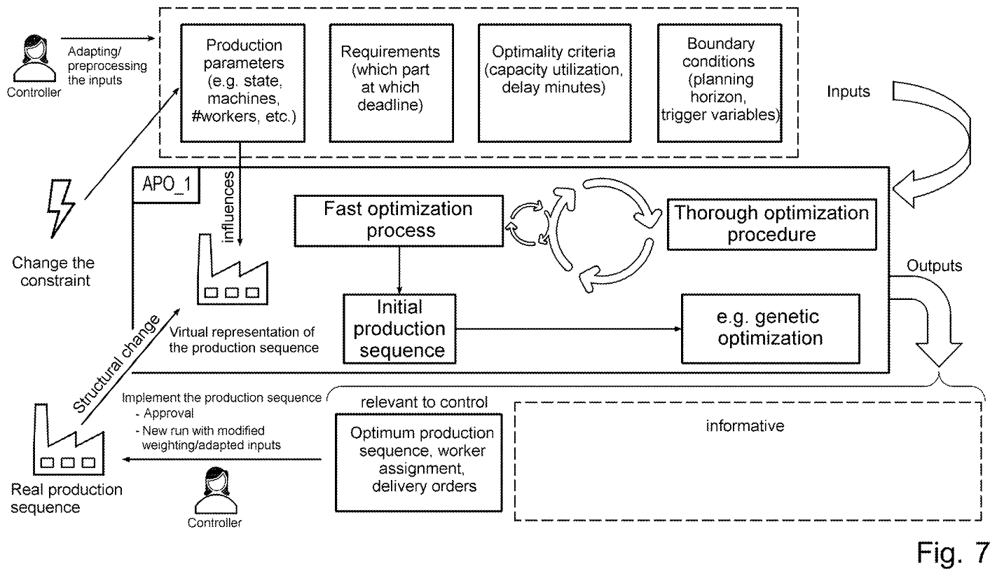

FIG. 7 shows a schematic exemplary embodiment of a production planning and/or control system according to the invention for adaptive production optimization,

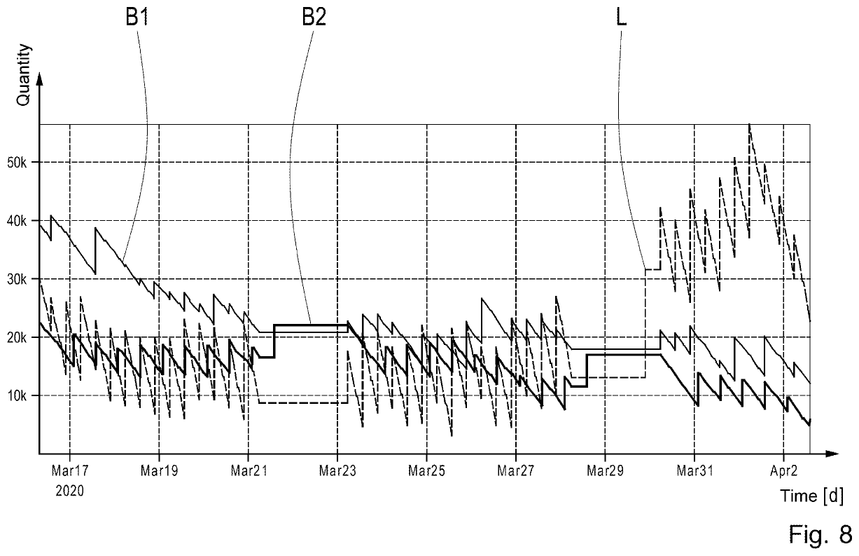

FIG. 8 shows a graphical representation of the progression of material stocks for supplied materials obtained by means of the method according to the invention and

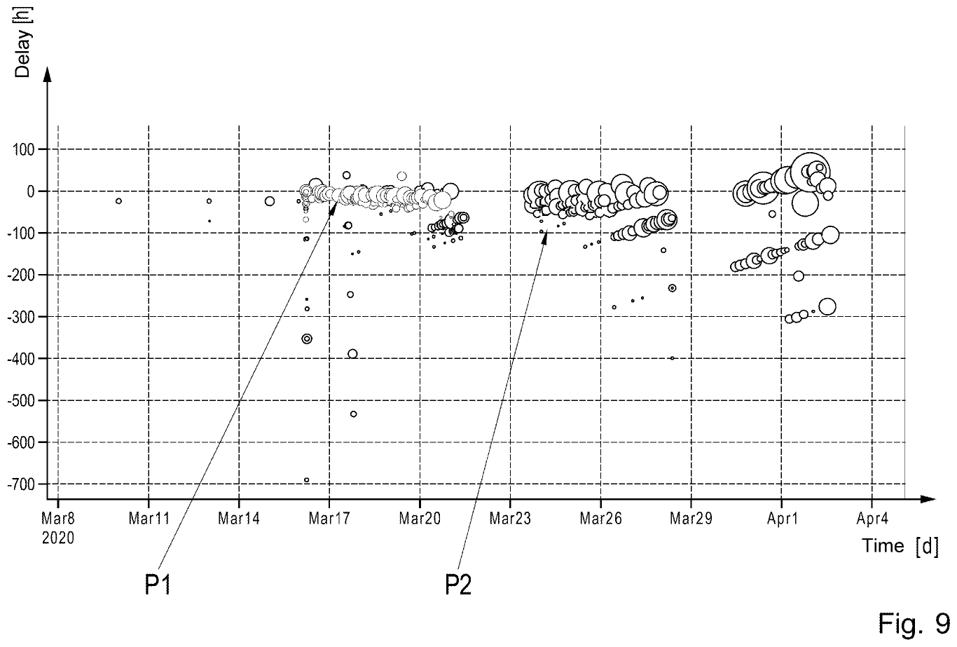

FIG. 9 shows a schematic representation of the material requirements fulfilment obtained by means of the method according to the invention.

In the figures, identical reference signs designate referenced components that are identical or functionally similar. For the sake of clarity, only the relevant reference parts are highlighted in the individual figures.

FIG. 1 shows a production model of a simplified production system. The production model comprises a first production section PA1 and a second production section PA2. The first production section PA1 and the second production section PA2 each comprise three production lines Line 1, Line 2 and Line 3. In addition, the first production section comprises a first material buffer Buffer 1 and the second production section comprises a second material buffer Buffer 2.

The first material buffer Buffer 1 comprises the materials produced in Lines 1, 2, 3 of the first production section PA1. The second material buffer Buffer 2 comprises the materials produced in Lines 1, 2, 3 of the second production section PA2. For example, the first material buffer Buffer 1 comprises 100 materials of type A. The second material buffer Buffer 2 comprises 200 materials of type B and 100 materials of type C. These quantities are included in the production parameters of the input data.

For example, exactly 1 piece of type A material is required to produce either 1 piece of type B material or 1 piece of type C material. The material requirements include, for example, material type, quantity or requirement quantity and requirement deadline. However, the method according to the invention and the system according to the invention are applicable to more complex production models with any dependencies and material requirements and also optimize such complex production models or entire production systems.

The sequence of the method according to the invention starts with the initialization. It takes the following form: A data structure is created from material requirements, which comprise such items as material type, quantity or requirement quantity, requirement deadline, priority, and weighting. The data structure organizes the material requirements according to their influence on the total cost function. The material requirements with the highest influence, i.e. the highest priority, are ranked first in a sequence. Furthermore, the data structure groups the material requirements according to production sections. If, for example, the total cost function is optimized with respect to delay minutes, the least-slack-time scheduling algorithm is advantageously used for ranking the material requirements. The material requirements are reduced, for example, according to the ordering based on the existing initial buffer stocks. This is shown in FIG. 2.

In the second production section PA2, the materials of type B have the earliest requirement deadline of 2:00 p.m. and are thus placed in first position, i.e. in the first line. As the second material Buffer 2 contains 200 type B materials, only 800 type B materials of the requirement quantity of 1000 need to be produced. As the second material Buffer 2 contains 100 type C materials, only 400 type B materials of the requirement quantity of 500 need to be produced. The type C materials have the requirement deadline of 6:00 p.m. and are thus ranked after the type B materials. In this example, there is no initial material requirement for the first production section PA1. This means that the data structure for the first production section PA1 is initially empty.

After initialization, the material requirements are propagated backwards through the production sections. The material requirements are projected onto the materials required for production on the following production section. For example, for the production of materials of material types B and C in the second production section PA2, material of material type A from the first production section PA1 is required. In addition to the material type, both the requirement quantity and requirement deadline are adjusted. The requirement quantity is reduced based on the initial buffer stocks. The period of time required for the production is deducted from the original requirement deadline. This is illustrated in FIG. 3.

For the first material requirement of 800 materials of material type B at the requirement deadline 2:00 p.m., 100 materials of material type A are already in the first material buffer Buffer 1. This means that only 700 materials of material type A must be produced. For example, four hours are needed to produce the first material requirement in the second production section PA2. This means that the requirement deadline in the first production section PA1 is 10:00 a.m. An analogous consideration applies to the second material requirement of 400 materials of type C at the requirement deadline of 6:00 p.m. For the second material requirement, the requirement deadline in the first production section PA1 is therefore 3:00 p.m.

Based on the requirement data structure, the algorithm according to the invention assigns lines, distributes workers and generates supplier orders. To do this, the following instructions are executed:

The virtual production system or the virtual factory is simulated from the start time. Whenever a production line is running empty, i.e. has no more orders, the next requirement with the highest priority that can run on the line is selected based on the above data structure. Due to secondary conditions such as line capacity, this does not necessarily have to be the first requirement in the data structure.

The requirement thus selected is implemented when there are sufficient input materials available to fully satisfy the requirement. In this case, the input materials are reserved for this requirement. If there are not enough supplied input materials available, a check is made to determine whether it is possible to deliver them at the current time. Constraints may include supplier capacities. In the positive case, a corresponding delivery is ordered and the delivered material is reserved. In the negative case, the next requirement is selected according to the data structure. If an input material can be both produced and delivered, then the initial delivery and buffer stocks are reduced as described above, with the difference that, in contrast to initial buffer stocks, the delivery time must be taken into account.

Reserving the input materials ensures that the production sequences defined in this way can be implemented, in other words, that orders created in this way can be executed in any case.

FIG. 4 shows a result of a fast optimization of the production system obtained with a first sub-method, namely an initial production sequence. The first sub-method comprises the steps V2 to V7. In a method step V8, a first production period is fixed in the second sub-method. For example, the time to the end of the current shift is fixed. Outside this period, the initial production sequence is more thoroughly optimized in a method step V9, for example by means of genetic optimization. According to one aspect of the invention, other parameters are fixed in the same way, for example deliveries and/or worker situation. According to a further aspect of the invention, the individual parameters are fixed with different horizons. For example, deliveries can only be changed up to twelve hours in advance. In a method step V10 the production system is open-loop and/or closed-loop controlled according to the production sequence optimized in the second sub-method.

FIG. 5 shows the temporal profile of the optimization result. The end of the fixation period is reached from time point 7. Within the period from 3 to 7, the cost function is only minimized to a minimal extent in the second sub-method. Therefore, a current iteration of the second sub-method is ended at time point 4 and a new iteration of the second sub-method is started.

FIG. 6 shows the method according to the invention. Method step V1 comprises a simulation of the production system, the production planning and/or control. This simulation is the input into the production planning and/or control system APO according to the invention. Outputs of the production planning and/or control system APO according to the invention comprise open-loop and/or closed-loop control signals in order to produce in a real factory according to the optimized production sequence obtained in the second sub-method. Furthermore, the outputs of the production planning and/or control system APO according to the invention comprise informational outputs for a controller of the production system.

In order to obtain the outputs, the production planning and/or control system APO according to the invention executes a first sub-method and the second sub-method. The first sub-method comprises the steps:
V2: Prioritizing material requirements in the production sections PA1, PA2 depending on their impact on the optimization of a cost function of the production system,
V3: Selecting one of the material requirements in the order of prioritization
V4: Adjusting at least one requirement quantity and/or one requirement deadline for materials in preceding production stages PA1, PA2 to implement the material requirement,
V5: Reserving the materials and the respective adjusted requirement quantity and/or requirement deadline,
V6: Selecting another of the material requirements, repeating the previous step until the materials and the adjusted requirement quantities and/or requirement deadlines for all of the prioritized material requirements are reserved, and
V7: Obtaining a production sequence.

Between the first sub-method and the second sub-method, if there are not enough materials available to fulfill the material requirement, in a method step a check is carried out to determine whether materials lacking for the material requirement can be delivered in compliance with the requirement deadline, wherein in the event of a positive check a delivery is ordered in a method step V11. The delivered materials are reserved in a method step V12. If the result of the check is negative, a further material requirement that is compliant is reserved.

Furthermore, in a method step V13 a data structure is generated between the first sub-method and the second sub-method from the prioritization of the material requirements. The data structure comprises at least material type, requirement quantity, and requirement deadline for each production section PA1, PA2. In addition, the data structure comprises an index structure by means of which entries in the data structure are referenced among one another. The second sub-method is executed to process the data structure and to assign the production lines Line 1, Line 2, Line 3, distribute workers, and/or generate supplier orders based on the data structure.

In addition, the first sub-method performs a first check to determine whether the adjusted requirement quantity of the respective materials is sufficient for the selected material requirement, wherein if the first check is positive the respective materials are reserved for the production system and/or the selected material requirement is implemented.

FIG. 7 shows an overview of the production planning and/or control system APO according to the invention, with which an adaptive production optimization is achieved by executing the method according to the invention. The rapid optimization procedure according to the invention, which is the first sub-method, is followed by a more thorough optimization procedure, which is the second sub-method. The more thorough optimization procedure comprises a genetic optimization, for example.

FIG. 8 shows the progression of a first material stock B1 and a second material stock B2 for delivered materials. Furthermore, FIG. 8 shows the progression of deliveries L, which are scheduled by the method and system according to the invention.

In FIG. 9, each bubble represents a material requirement. There are three different categories: “most important”, “important” and “less important”. In FIG. 9, a first category P1 corresponding to “most important” and a second category “important” are indicated. The abscissa indicates the times at which the material requirements are expected to be met. The size of the bubbles represents the requirement quantity. The ordinate indicates the delay at the time the requirement is fulfilled. Everything located above 0 would be delayed.

### Reference Signs

V1-V14 method steps
PA1 production section 1
PA2 production section 2
Line 1,2,3 production lines
Buffer 1 material buffer
Buffer 2 material buffer
A,B,C material types
APO production planning and/or control system
L delivery quantity
B1 first material stock
B2 second material stock
P1 first category
P2 second category

1. A computer-implemented method for planning and/or controlling a production by a production system comprising a plurality of production sections and production lines, the method comprising:
simulating the production system, the production planning and/or the control of the production;
in the simulation, carrying out a first sub-method and a second sub-method, wherein the first sub-method comprises:
prioritizing material requirements in the production sections depending on their impact on the optimization of a cost function of the production system;
selecting one of the material requirements in order of prioritization, adjusting at least one requirement quantity and/or one requirement deadline of materials in preceding production sections to implement the material requirements and reserving the materials and the adjusted requirement quantity and/or the requirement deadline; and
selecting another of the material requirements, repeating the previous step until the materials and the adjusted requirement quantities and/or requirement deadlines for all of the prioritized material requirements are reserved, and obtaining a production sequence;
and wherein the second sub-method comprises:
fixing a first production period in the production sequence; and
optimizing the production sequence outside the fixed first production period to further optimize the cost function,
wherein the production system is open-loop and/or closed-loop controlled according to the optimized production sequence obtained in the second sub-method.

2. The method according to claim 1, wherein an iteration of the second sub-method is terminated in response to no significant optimization of the production sequence being obtained, and a further iteration of the second sub-method is started.

3. The method according to claim 1, comprising:
executing an evolutionary algorithm for carrying out the second sub-method, which evolutionary algorithm is initialized with the production sequence obtained in the first sub-method or a mutation of the first sub-method.

4. The method according to claim 1, further comprising:
simulating production parameters, optimality criteria and/or constraints, wherein the production parameters comprise worker situation, machine capabilities, material availabilities, material buffers and/or supplier capacities, the optimality criteria comprise maximum utilization of the machines and/or workers, minimization of delays, lowest stock levels and/or minimization of material flows and the constraints comprise priorities of material requirements, maximum warehouse and/or material buffer sizes, transport conditions, planning horizon, and/or supplier capacities.

5. The method according to claim 1, further comprising:
simulating a shift operation of workers and assigning workers to the production lines in the simulation, wherein any change in the assignment of workers to the production lines is carried out at least depending on the material requirements and/or material stocks.

6. The method according to claim 1, further comprising:
checking whether materials lacking for the material requirements can be delivered in compliance with the requirement deadline in response to insufficient materials being available to implement the material requirements, wherein in the event of a positive check a delivery is ordered and the delivered materials are reserved and in the event of a negative check, a further materials requirement that is compliant is reserved.

7. The method according to claim 1, further comprising:
generating a data structure as a result of the prioritization of the material requirements, wherein the data structure comprises at least material type, requirement quantity and requirement deadline for each production section, and wherein the data structure also comprises an index structure wherein entries in the data structure are referenced among one another, wherein the second sub-method is executed to process the data structure and the production lines are assigned, workers are distributed, and/or supplier orders generated based on the data structure.

8. The method according to claim 1, further comprising:
providing open-loop and/or closed-loop control-related outputs and/or informational outputs, wherein the open-loop and/or closed-loop control-related outputs comprise production sequences, worker assignment and/or supplier orders and the informational outputs comprise material requirements coverage, completion dates, capacity utilization, bottlenecks, critical paths, and/or temporal progression of the production system.

9. The method according to claim 1, further comprising:
generating a digital twin of a real factory in the simulation;
determining a planning horizon for the digital twin; and
controlling the real factory using the planning horizon.

10. A production planning and/or control system for the optimization of production, comprising a processing unit configured to carry out the method according to claim 1.

11. The system according to claim 10, comprising:
at least one interface, via which communication between the system and a controller of the system is provided, wherein the system provides open-loop and/or closed-loop control-related outputs and/or informational outputs of the system to the controller via the interface and the interface provides optimization results to the controller.

12. The system according to claim 10, comprising:
a cloud infrastructure, the cloud infrastructure comprising a cloud-based storage, wherein a simulation of the production system, the production planning and/or control takes place in the cloud.
